(19) United States
(12) Patent Application Publication
(10) Pub. No.: US 2012/0158765 A1
(43) Pub. Date: Jun. 21, 2012

(54) User Interface for Interactive Query Reformulation

(75) Inventors: Girish Kumar, Kirkland, WA (US); Sanaz Ahari, Bellevue, WA (US); Farid Hosseini, Redmond, WA (US); Mingrui Wu, Redmond, WA (US); Ahmad Abdulkader, San Jose, CA (US); Ankur Gupta, Redmond, WA (US); Giridhar Kumaran, Issaquah, WA (US); Abdigani M. Diriye, London (GB)

(73) Assignee: MICROSOFT CORPORATION, Redmond, WA (US)

(21) Appl. No.: 12/969,218

(22) Filed: Dec. 15, 2010

(51) Int. Cl. G06F 17/30

(52) U.S. Cl. 707/766; 707/E17.015

(57) ABSTRACT

Computer-readable media, computer systems, and computing methods are provided for classifying search results as either of good quality or of poor quality. Initially, a portion of the search results, such as the highest ranked documents, are selected for evaluation. A level of quality for each of the selected search results is determined using a classification process that includes the following steps: targeting features demonstrated by the selected search results to be evaluated; evaluating the selected features to generate a level-of-quality score for each of the selected search results; comparing the score against a predefined threshold value; and, based on the comparison, assigning each of the selected search results an absolute measurement. The absolute measurement indicates poor quality when the score is less than the threshold value. Upon recognizing that the selected search results are of poor quality, a corrective action that reformulates the issued search query is automatically invoked.

### CROSS-REFERENCE TO RELATED APPLICATIONS

This application is related to U.S. application No. ______ (Attorney Docket Number MS#331078.01/MFCP.157702) filed Dec. 15, 2010, entitled “CLASSIFYING RESULTS OF SEARCH QUERIES,” the teachings of which are hereby incorporated by reference in their entirety.

### BACKGROUND

Search engines are generally designed with the intent to simplify users' lives by helping them find relevant search results (e.g., documents) that match their search queries in a fast and effective way. For instance, users of search engines may compose and submit search queries in order conduct an online search for a service, product, particular information, or any other data targeted by the user intent behind the search query. Often, the set of search results generated by the conventional search engines are of poor quality, meaning that at least a portion of the set of search results does not properly satisfy the user's intent behind the search query. Specifically, in one study, researchers discovered that the top-listed results in roughly one in ten sets of search results were irrelevant to the user's intent of the corresponding search query.

There are various reasons for generating poor-quality search results. Some reasons involve a lack of good-quality documents in a web index being interrogated by the search engine or a failure of a core-ranking algorithm to locate the good-quality documents that exist within the web index.

### SUMMARY

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

Embodiments of the present invention address various reasons for generating poor-quality search results including the following: poor user composition of search queries in a format that matches poor-quality documents or other documents that do not satisfy the user's intent behind the search query. These defectively composed search queries may either include extremely common terms that can be interpreted in a multitude of different ways (generating off-topic search results), or include rare terms that do not match any return meaningful documents (generating obscure search results).

Yet, search engines return these off-topic or obscure search results to the user regardless of whether they are actually relevant to the user's intent. This gives the user the false impression that, because the search results matched their search query, the returned search results must be relevant. Upon inspection, however, users often find that the search results are not relevant. Further, if the user desires better, good-quality documents (used interchangeably with the phrase “search results” herein), the user is forced to recompose their search query without any assistance. This deficiency of search engine results in an inefficient and confusing user search experience.

Accordingly, because search engines fail to recognize that poor-quality search results are being offered to the user as a result of the user's defectively composed search query, a novel search engine that automatically determines when the returned search results are of poor quality and, when poor-quality search results are determined, takes corrective action to improve the search query (i.e., re-articulating the user's intent in the context of online searching) would provide an enhanced overall user experience.

Embodiments of the present invention address the problematic issue that many users do not possess proficient search-query formulation skills. For instance, users often type over-extensive or under-inclusive search queries and, upon issuing the search queries to a search engine, users receive search results that are irrelevant to the users' true intent. Other embodiments address the problematic issue that some search queries are inherently vague (e.g., using common terms) or difficult to satisfy (e.g., using rare terms) regardless of how they are formulated.

Accordingly, embodiments of the present invention introduce various methods for detecting irrelevant search results and assisting a user in improving search-result relevance. In one instance, the detection of irrelevant search results is performed by a search engine that attempts to build a classification process for automatically determining a level of quality of search results within a search-engine results page (SERP) for a given user-initiated search query at runtime. In an exemplary embodiment, the search engine implements the classification process to ascertain whether the search results are acceptable in an absolute sense (e.g., either good quality or poor quality) based, in part, on the determined level of quality. Further, when these search results are determined to be of poor quality, they are labeled as such so that one or more corrective actions may be carried out, if appropriate.

Because alterations to a user's search query, such as minor tweaks to terms therein, often improve the relevance of the returned search results, one of the corrective actions may involve implicitly rewriting the search query on the user's behalf. In cases where there is high confidence that the alterations will improve the search results, the rewritten search query is prepared and submitted by the search engine automatically in a transparent manner. In cases where there is a low confidence that the alterations will improve the search results, options for altering key terms (e.g., remove or replace) are explicitly presented to the user to solicit his or her feedback for reformulating the search query. In addition to helping the user reformulate his or her search query, another corrective action may include presenting search results identified to be of good quality, while suppressing those of poor quality. Accordingly, the user is spared the time involved in perusing through poor-quality search results.

### BRIEF DESCRIPTION OF THE DRAWINGS

Embodiments of the invention are described in detail below with reference to the attached drawing figures, wherein:

FIG. 1 is a block diagram of an exemplary computing device suitable for implementing embodiments of the invention;

FIG. 2 is a schematic diagram depicting a first illustrative UI display that includes a reformulation UI for altering key terms within a search query, in accordance with embodiments of the invention;

FIG. 3 is a block diagram of an exemplary network environment suitable for use in implementing embodiments of the invention;

FIG. 4 is a schematic diagram depicting a second illustrative UI display that includes search results of poor quality that are generated by a search engine, in accordance with embodiments of the invention;

FIG. 5 is a schematic diagram depicting a third illustrative UI display that includes the reformulation UI for improving a relevance of the search results of FIG. 4, in accordance with embodiments of the invention;

FIG. 6 is a schematic diagram depicting a fourth illustrative UI display that includes the reformulation UI that exposes various preset suggestions for altering key terms of a search query, in accordance with embodiments of the invention;

FIG. 7 is a flow diagram showing an overall method for invoking a reformulation UI upon determining that a set of search results are of low quality, in accordance with embodiments of the invention; and

FIG. 8 is a flow diagram showing an overall method for selecting a corrective action in response to low-quality search results, in accordance with embodiments of the invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

As can be gleaned from the disclosure below, various embodiments of the present invention pertain to determining a level of quality of search results and, potentially, taking a corrective action to improve the determined level of quality utilizing task-based engines (e.g., decision engines, task engines, individual applications or operations, applet systems, operating systems, and task-based mobile systems), or general systems that attempt to match search results to a user intent inherent within an issued search query. For simplicity of discussion, these engines and/or systems will be hereinafter referred to as “search engines.”

Embodiments of the invention described herein include computer-readable media having computer-executable instructions embodied thereon. When executed (e.g., using a processor), the computer-executable instructions perform a method for invoking a reformulation user interface (UI) upon determining that a set of search results are of low quality. In embodiments, the method includes the steps of receiving a search query issued by a user and returning the set of search results generated based upon content of the search query. The method may further involve determining that a portion of the set of search results are of poor quality upon applying a classifying process thereto.

In embodiments, key terms are identified within the search query. Often, the key terms are identified by ignoring non-critical, common natural language from the search query. Upon determining that a set of search results are of low quality, the search engine may render the reformulation UI to expose to the user preset suggestions in association with each of the key terms. When at least one user-initiated selection is detected that targets one or more of the preset suggestions, the search query may be altered in accordance with the user-initiated selection on the targeted preset suggestion(s).

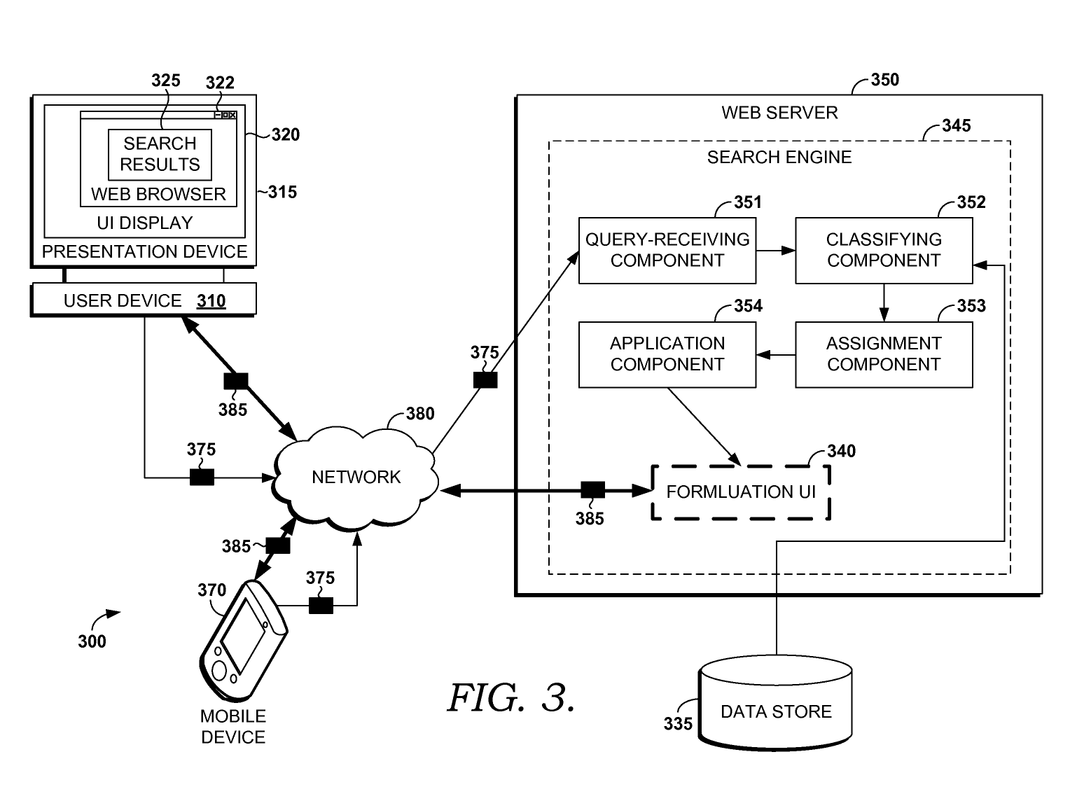

In a second illustrative embodiment, the present invention introduces a computer system for invoking a reformulation user interface (UI). In one instance, the computer system includes a processing unit coupled to a computer-storage medium, where the computer storage medium stores a plurality of computer software components executable by the processing unit. As illustrated in FIG. 3, the computer system includes at least the computer software components comprising: a query-receiving component; a classifying component; and an application component.

The query-receiving component is configured to receive a search query issued by a user and to return the set of search results generated based upon the search query. In other embodiments, the classifying component is adapted to identify the query-receiving component returned search result(s) of poor quality within the set of search results. Generally, the application component is configured to invoke an appropriate corrective action upon detecting the poor-quality search result(s). In an exemplary embodiment, the appropriate corrective action is selected based on, in part, a level of confidence in an automatically rewritten search query producing new search results that are more relevant to the user's intent of the issued search query than the returned set of search results. In one instance, the appropriate corrective action comprises rendering the reformulation UI when the level of confidence is determined to be low. In another instance, the appropriate corrective action comprises issuing the automatically rewritten search query to generate the new set of search results when the level of confidence is determined to be high.

In a third illustrative embodiment, a computerized method carried out by a search engine (running on a processor) for selecting a corrective action in response to low-quality search results. Initially, the method includes providing a set of search results returned in response to a search query issued by a user of the search engine. The search engine may target one or more of the set of search results that are ranked as highly relevant to the issued search query. In embodiments, a determination that the targeted search result(s) demonstrate a low level of quality is made. Typically, the determination of a low level of quality is made based on a relevance of the targeted search result(s) to the issued search query.

In an exemplary embodiment, the search engine is responsible for estimating a high or low confidence, where a level of the confidence is based upon whether a rewritten search query will generate new search results that are more relevant to the issued query than the returned set of search results. The rewritten search query, in embodiments, is automatically generated by the search engine upon determining that the targeted search result(s) demonstrate a low level of quality. In one instance, when a high confidence is estimated, the search engine automatically issues the rewritten search query to generate the new search results. In another instance, when a low confidence is estimated, the search engine launches an interactive query refinement tool that assists the user in altering key terms of the issued search query.

Generally, as discussed more fully below, the interactive query refinement tool is responsible for implementing actions. Some exemplary actions include identifying one or more replacement terms for each of the key terms of the search query and presenting the replacement term(s) on a search-results page in proximity to the key terms. In operation of the tool, at least one key term within the issued search query is replaced by the selected replacement term(s) upon detecting a user-initiated selection directed toward the presented replacement term(s).

Having described an overview of embodiments of the present invention, an exemplary operating environment in which embodiments of the present invention may be implemented is described below in order to provide a general context for various aspects of the present invention.

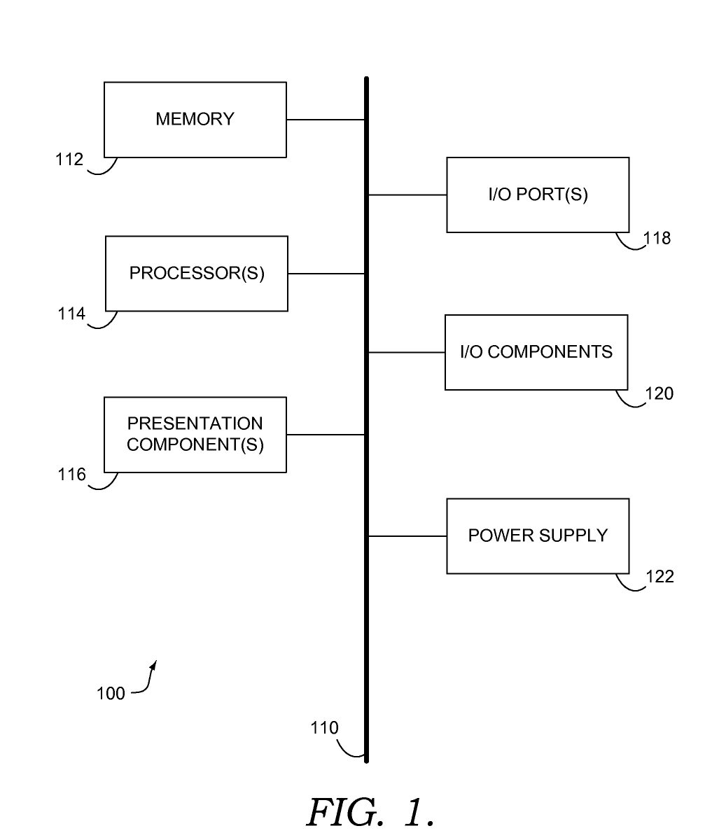

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. In embodiments, the computer storage media represents tangible computer readable media, such as medium embodied on a processor.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. In embodiments, the communication media represents non-transitory computer readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

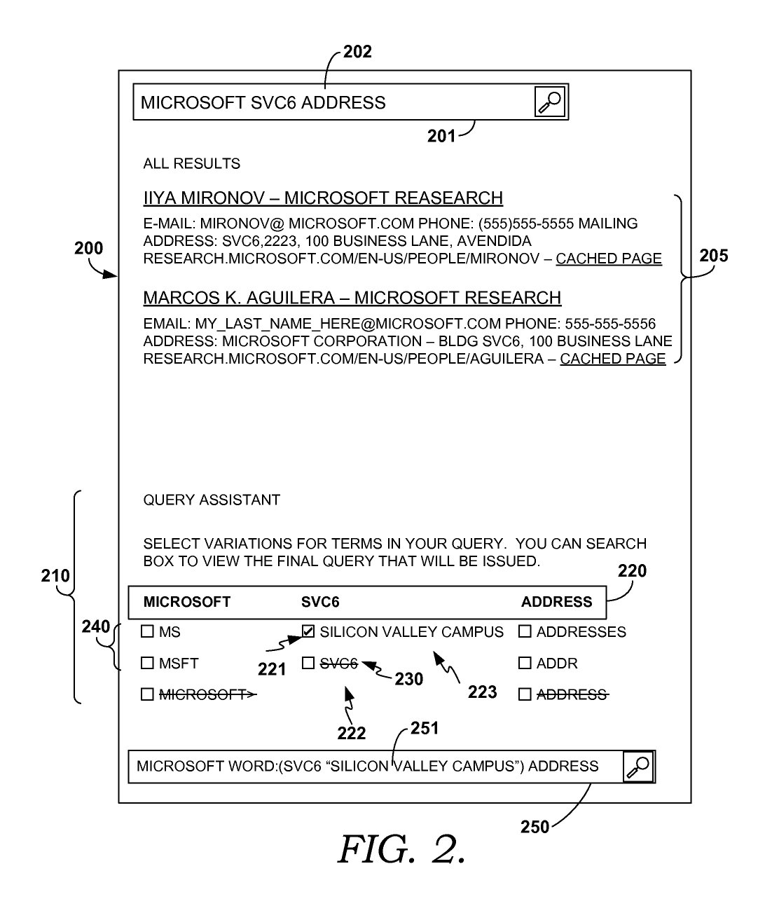

Turning now to FIG. 2, a schematic diagram depicting a first illustrative UI display 200 that includes a reformulation UI for altering key terms within a search query, in accordance with embodiments of the invention. Initially, a search query 202 of “Microsoft SVC6 Address” is entered into a query-receiving area 201 by a user. The search query 202 is then employed to generate search results 205. Upon the search engine evaluating the search results returned from an issued search query, the search engine may determine that the search results 205 are of poor quality (i.e., irrelevant to a user intent of the search query 202).

When the search engine determines the search results 205 are of poor quality (e.g., using a classification process described below), one or more corrective actions are invoked. As depicted in FIG. 2, the corrective actions that are invoked include presenting on a search-engine results page (SERP) a portion of the search results 205 while abstaining from showing a remainder of the set of search results, rendering a reformulation UI 210 that allows the user to alter key terms 220 of the search query 202, and presenting an altered search query area 250 that surfaces an altered search query 251. Typically, the altered search query 251 reflects alterations made to the search query 202 upon detecting the user-initiated selection on one or more preset suggestions 240.

In one instance, a group of preset suggests 222 for the search-query term “SVC6” may include a drop option 230. A user-initiated selection at the drop option 230 will remove the term “SVC6” from the search query 202. In another instance, a group of preset suggestions 222 for the search-query term “SVC6” may include a replacement term 223. A user-initiated selection at the replacement term 223 will replace the term “SVC6” within the search query 202 with an expanded meaning of the acronym “Silicon Valley Campus.” The user-initiated selection is revealed by modifying a selectable control 221 (e.g., checking a check box or highlighting a dial control) proximate to the replacement term 223. In another embodiment, the replacement term 223 is incorporated into the altered search query 251, as illustrated in FIG. 2.

Accordingly, the reformulation UI 210 acts as rich user-interactive display that allows a user to dynamically modify the search query 202. In one instance, the reformulation UI 210 generates and displays the preset suggestions 240, as discussed above. Although replacement terms 223 and drop options 230 are illustrated in FIG. 2, many other preset suggestions 240 may be offered to the user. By way of example, an add option may be offered within the preset suggestions 240 that allows a user to add a term to the altered search query 251, which the search engine provides for clarification of the search query 202.

In embodiments, the replacement terms 223 of the preset suggestions 240 are selected by the search engine based on various factors. Initially, the search engine may dynamically access an alteration service (not shown) to inspect a group of terms that may serve as suitable replacement terms (e.g., synonyms within the context of an online search) for the key terms 220 of the search query 202. The alteration service generally performs an offline process that identifies a group of terms as candidates for the replacement terms. Often, the alteration service compiles these candidates based on previous experience (e.g., user behavior extracted from query logs). By way of example, the alteration service monitors user behavior to create a path between terms that are deemed to be interchangeable or refinements of one another.

In the instance of multi-user social activity, the alteration service may observe various users refining a search by switching out a particular term. This switched-out term and its replacement may be linked by a path indicating they are synonymous with each other. Or, the alteration service may recognize that similar popular searches have one term replaced by another. For example, the alteration service may notice that some users commonly issue a search query for “desktop computer sales,” while other users commonly issue a search query for “laptop computer sales.” The alteration service, upon determining that similar search results are generated for both search queries immediately above, may identify “laptop” as a suitable replacement for “desktop” within the context of computers. Upon identifying terms as suitable replacements, the alteration service may draw a path between the terms to designate them as replacements. As such, the “path” links the related terms in a storage location for eventual selection by the reformulation UI 210 of FIG. 2.

In the instance of individual user activity, the alteration service may track a single user's online activity over a single session (e.g., searching over discrete period of time). For instance, during a single session, when the user issues a search query that includes the term “desktop” and then refines the search query to include “laptop” in the place of “desktop,” the alteration service learns that one is a valid reformation of the other term. Consequently, the alteration service may link the terms “laptop” and “desktop” via a path.

Upon linking related terms together via paths, the alteration service may organize related terms into groupings that facilitate subsequent access by the search engine. In an exemplary embodiment, the alteration service may attach a confidence score to each of the terms assembled within a particular grouping. As used herein, the phrase “confidence score” generally represents a level of interchangeability of the terms within the groupings. For instance, a confidence score may be based on a number of users that have interchanged the terms on a term-level, as opposed to a query-level. Generally, the greater the number of users, or the greater the frequency of replacement, the higher the confidence score. In operation, the confidence scores are employed to select replacement terms 223 from potential candidate terms within a grouping associated with a key term of the search query 202. Often, those candidates that exhibit the highest-level confidence scores are revealed by the reformulation UI 210 as replacement terms. Advantageously, the alteration service provides the user with the most commonly taken action by online users or the most useful action to the user, based on the user's online history.

The system architecture for implementing the method of making an absolute measurement of at least one search result and taking one or more corrective actions will now be discussed with reference to FIG. 3. Initially, FIG. 3 is a block diagram illustrating a distributed computing environment 300 suitable for use in implementing embodiments of the present invention. The exemplary computing environment 300 includes a user device 310, a data store 335, a web server 350, a mobile device 370, and a network 380 that interconnects each of these items. Each of the user device 310, the data store 335, the web server 350, and the mobile device 370, shown in FIG. 3, may take the form of various types of computing devices, such as, for example, the computing device 100 described above with reference to FIG. 1. By way of example only and not limitation, the user device 310, the web server 350, and/or the mobile device 370 may be a personal computer, desktop computer, laptop computer, consumer electronic device, handheld device (e.g., personal digital assistant), various servers, processing equipment, and the like. It should be noted, however, that the invention is not limited to implementation on such computing devices but may be implemented on any of a variety of different types of computing devices within the scope of embodiments of the present invention.

Typically, each of the user device 310, the web server 350, and the mobile device 370 includes, or is linked to, some form of a computing unit (e.g., central processing unit, microprocessor, etc.) to support operations of the component(s) running thereon (e.g., query-receiving component 351, classifying component 352, assignment component 353, application component 354, and the like). As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the user device 310, the web server 350, and/or the mobile device 370, respectively, in order to enable each device to perform communication-related processes and other operations (e.g., rendering the reformulation UI 210 of FIG. 2). In another instance, the computing unit may encompass processor(s) (not shown) coupled to the computer-readable medium accommodated by each of user device 310, the web server 350, and the mobile device 370.

Generally, the computer-readable medium includes physical memory that stores, at least temporarily, a plurality of computer software components that are executable by the processor. As utilized herein, the term “processor” is not meant to be limiting and may encompass any elements of the computing unit that act in a computational capacity. In such capacity, the processor may be configured as a tangible article that processes instructions. In an exemplary embodiment, processing may involve fetching, decoding/interpreting, executing, and writing back instructions.

Also, beyond processing instructions, the processor may transfer information to and from other resources that are integral to, or disposed on, the user device 310, the web server 350, and the mobile device 370. Generally, resources refer to software components or hardware mechanisms that enable the user device 310, the web server 350, and the mobile device 370 to perform a particular function. By way of example only, resource(s) accommodated by the web server 350 operate to assist the search engine 345 in receiving inputs from a user at the user device 310 or the mobile device 370 and/or providing an appropriate communication in response to the inputs (e.g., rendering search results 325).

The user device 310 may include an input device (not shown) and a presentation device 315. Generally, the input device is provided to receive input(s) affecting, among other things, search results 325 rendered by a search engine 345 and surfaced at a UI display 320. Illustrative input devices include a mouse, joystick, key pad, microphone, I/O components 120 of FIG. 1, or any other component capable of receiving a user input and communicating an indication of that input to the user device 310. By way of example only, the input device facilitates entry of a search query 375, which is communicated over the network 380 to the web server 350 for processing by the search engine 345.

In embodiments, the presentation device 315 is configured to render and/or present the UI display 320 thereon. The presentation device 315, which is operably coupled to an output of the user device 310, may be configured as any presentation component that is capable of presenting information to a user, such as a digital monitor, electronic display panel, touch-screen, analog set-top box, plasma screen, audio speakers, Braille pad, and the like. In one exemplary embodiment, the presentation device 315 is configured to present rich content, such as the search results 325, associated advertisements, and digital images and videos. In another exemplary embodiment, the presentation device 315 is capable of rendering other forms of media (i.e., audio signals).

The data store 335 is generally configured to store information associated with selecting preset suggestions for presentation in a reformulation UI. In operation, when the user is implementing a search at the search engine 345, the search engine 345 may access the information residing at the data store 335, such as candidate replacement terms for one or more of the key terms within a search query.

In other embodiments, the data store 335 may be configured to be searchable for suitable access to the information maintained thereby. For instance, the data store 335 may be searchable for preset options. It will be understood and appreciated by those of ordinary skill in the art that the information stored in the data store 335 may be configurable and may include any information relevant to the determination and/or the retrieval of the a search-result level of quality, as well as the selection of the corrective actions that are triggered therefrom. The content and volume of such user-interaction information are not intended to limit the scope of embodiments of the present invention in any way. Further, though illustrated as single, independent components, the data store 335 may, in fact, be a plurality of databases, for instance, a database cluster, portions of which may reside on the user device 310, the web server 350, the mobile device 370, another external computing device (not shown), and/or any combination thereof.

This distributed computing environment 300 is but one example of a suitable environment that may be implemented to carry out aspects of the present invention and is not intended to suggest any limitation as to the scope of use or functionality of the invention. Neither should the illustrated distributed computing environment 300 be interpreted as having any dependency or requirement relating to any one or combination of the devices 310, 350, and 370, the data store 335, and components 351-354 as illustrated. In some embodiments, one or more of the components 351-354 may be implemented as stand-alone devices. In other embodiments, one or more of the components 351-354 may be integrated directly into the web server 350, or on distributed nodes that interconnect to form the web server 350. It will be appreciated and understood that the components 351-354 (illustrated in FIG. 3) are exemplary in nature and in number and should not be construed as limiting.

Accordingly, any number of components may be employed to achieve the desired functionality within the scope of embodiments of the present invention. Although the various components of FIG. 3 are shown with lines for the sake of clarity, in reality, delineating various components is not so clear, and, metaphorically, the lines would more accurately be grey or fuzzy. Further, although some components of FIG. 3 are depicted as single blocks, the depictions are exemplary in nature and in number and are not to be construed as limiting (e.g., although only one presentation device 315 is shown, many more may be communicatively coupled to the user device 310).

Further, the devices of the exemplary system architecture may be interconnected by any method known in the relevant field. For instance, the user device 310, the web server 350, and the mobile device 370 may be operably coupled via a distributed computing environment that includes multiple computing devices coupled with one another via one or more networks (not shown). In embodiments, the network may include, without limitation, one or more local area networks (LANs) and/or wide area networks (WANs). Such networking environments are commonplace in offices, enterprise-wide computer networks, intranets, and the Internet. Accordingly, the network is not further described herein.

In operation, the components 351-354 are designed to perform a process that includes, at least, taking corrective actions when the search results are deemed to be of poor quality. Initially, the search engine 345 includes the query-receiving component 351 configured to receive the search query 375 issued by a user and to return the set of search results 325 that are generated, in part, based upon the search query 375. In this way, the query-receiving component 351 acts as a frontend mechanism that interfaces with a user, while the backend mechanism retrieves the search results 325 from a web index.

The classifying component 352 is configured to carry out the classification process that automatically determines a quality measurement of one or more search results of the set of search results 325. Generally, the classification process is employed to automatically determine whether the search results 325 are acceptable (i.e., satisfy the user intent of the search query 375) in an absolute sense. Typically, the classification process includes the steps of evaluating various features exhibited by the search result(s) 325 to determine an overall level of quality and deriving the absolute measurement from the overall level of quality determined for each of the search result(s) 325. Generally, the absolute measurement identifies the search result(s) 325, respectively, as either of good quality or of poor quality in a mutually exclusive manner.

In an exemplary embodiment, the assigning component 353 is configured to label each of the search result(s) 325 as either “good quality” or “poor quality” based on an outcome of the classification process. These labeled search results are passed to the application component 354, that invokes an appropriate corrective action when one or more of the search results (e.g., the X-number of highest ranked search results or a majority of the search results on the SERP) are labeled as “poor quality.”

In an exemplary embodiment, the appropriate corrective action is selected as a function of a level of confidence. As used herein, the “level of confidence” is not meant to be limiting in definition, but encompasses any metric that relates to a likelihood that any alternative terms within a rewritten search query, offered by the application component 354, will produce new search results that are improved over the current “poor quality” search results 325. Concisely, in embodiments, the level of confidence indicates a probability that a search-engine composed search query will produce enhanced search results. In application, the level of confidence is used to select one or more corrective actions, such as rendering a reformulation user interface (UI) 340, alerting a user that the search result(s) 325 are labeled “poor quality” via a notification message, abstaining from presenting to the user the poor-quality search results, or automatically rewriting the search query 375 to generate an updated set of search results.

In an exemplary embodiment, the search query 375 is automatically rewritten and automatically issued upon calculating a high level of confidence in the alternative terms suggested by the application component 354. In contrast, the reformulation UI 340 is rendered upon calculating a low level of confidence in the alternative terms suggested by the application component 354. In one instance, the reformation UI 340 solicits and accepts user-initiated interactions 385, such as mouse-click selections, for guiding the alteration of key terms within the search query. By way of example, altering key terms may involve replacing or removing one or more key terms within the search query 375.

Although various different methods enhancing the search results 325 upon determining that one or more search results are labeled “poor quality” have been described, it should be understood and appreciated that other types of suitable methods and interfaces for selecting and implementing corrective actions may be used, and that embodiments of the present invention are not limited to those corrective actions discussed above. For instance, an additional corrective action may involve presenting a third-party entity the opportunity to reformulate the search query 375 using the third-party entity's experience and resources.

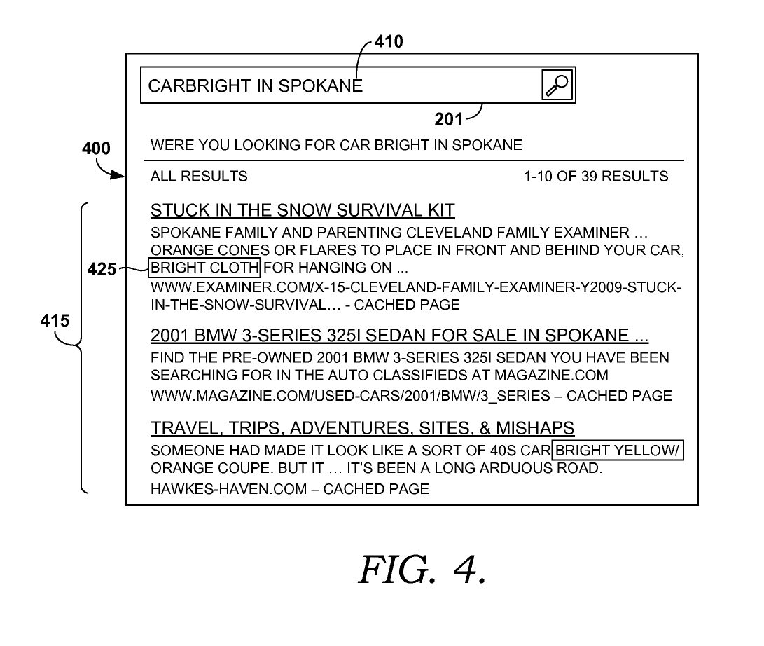

Turning now to FIG. 4, a schematic diagram depicting a second illustrative UI display 400 that includes search results 415 of poor quality that are generated by a search engine is shown, in accordance with embodiments of the invention. Initially, the search query “Carbright in Spokane” 410 is entered within the query-entry area 201. As illustrated, the matching terms “bright cloth” 425 within the search results 425 do not appear be relevant to the user's intent of the search query 410. Accordingly, the search engine may determine that the search results 415 are of poor quality and invoke one or more corrective actions.

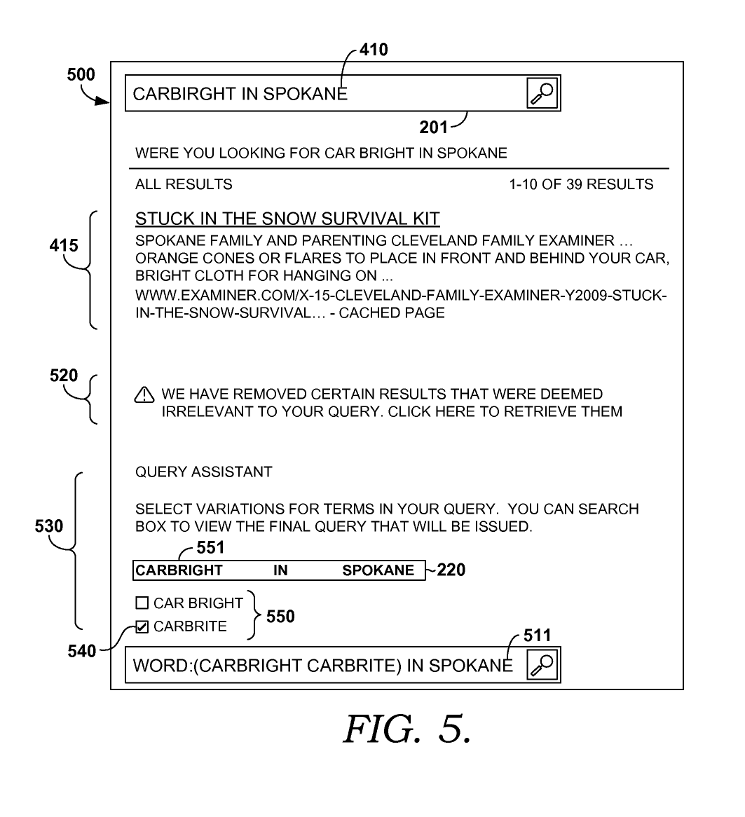

With reference to FIG. 5, a schematic diagram depicting a third illustrative UI display 500 that includes a reformulation UI 530 for improving a relevance of the search results 415 of FIG. 4 is shown, in accordance with embodiments of the invention. In embodiments, the reformulation UI 530 lists the key terms 220 of the search query 410. As illustrated, only one of the key terms “Carbright” 551 is provided with preset suggestions 550. These preset suggestions 550 are each paired with a selectable control proximate thereto. For instance, the replacement term “Carbrite” of the preset suggestions 550 is displayed in association with a selectable control 540 configured as a check box. In operation, a user-initiated selection targeting the selectable control 540 may incorporate replacement term “Carbrite” within an altered search query 511 by replacing the key word “Carbright” 551.

Beyond the reformulation UI 530, other corrective actions are taken. For instance, irrelevant search results 415 are removed from the SERP, in comparison to FIG. 4. Also, a notification message 520 is displayed alerting a user that certain query results 415 were deemed irrelevant and, thus, suppressed.

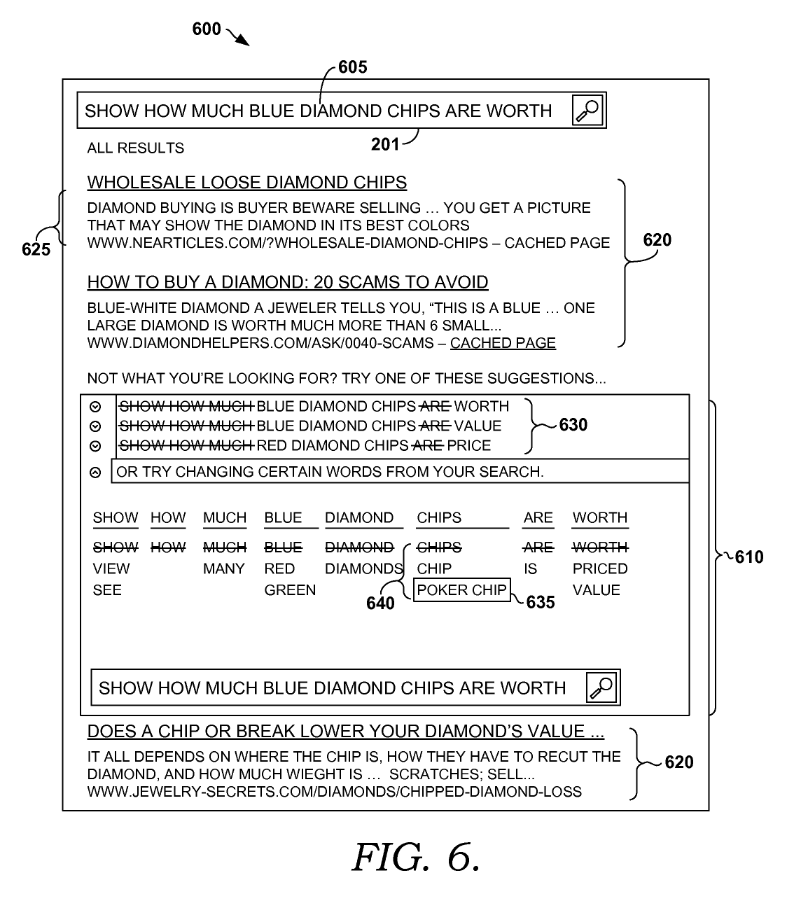

With reference to FIG. 6, a schematic diagram depicting a fourth illustrative UI display 600 that includes a reformulation UI 610 that exposes various preset suggestions 640 for altering key terms of a search query 605, in order to improve the search results 620, is shown, in accordance with embodiments of the invention. In this exemplary reformulation UI 610, replacement terms 635 are offered within the preset suggestions 640, as well as replacement search queries 630. In operation, a user-initiated selection of one of the replacement search queries 630 will change the search query 605 to an altered search query that matches the selected replacement query. Typically, the replacement search queries 630 are generated by the alteration service in a similar fashion as the replacement terms within the preset suggestions 640, as discussed more fully above.

As shown, with respect to the key term “Chips” of the search query 605, the preset suggestions 640 include replacement terms/phrases (“Chip” and “Poker Chip”) and an option to remove the key term (“Chips”). In the embodiment shown in FIG. 6, the replacement terms 640 are presented without selectable controls, such as check boxes or radio buttons. Instead, a user may select a desired preset suggestion 640 by selecting a representation (e.g., text) of one or more preset suggestions 640 directly. In one instance, a highlight element 635 (e.g., bold text, highlighting, border around text, and the like) may appear in association with the particular preset suggestion that the user's cursor overlays, thereby notifying the user which of the preset suggestions 640 will be invoked upon the user performing a selection action.

It should be noted that the replacement phrase “Poker Chip,” which is distinguished by the highlight element 635, includes the term “Poker,” which was not originally present within the search query 605. Further, the term “Poker” is neither a synonym (e.g., “Show” to “View” or “See”) a similar descriptor (e.g., “Blue” to “Green” or “Red”), nor an expansion/truncation/variation (e.g., “Chips” to “Chip”) of a term within the search query 605. Instead, the term “Poker” is a word derived by the alteration service that frequently appears in documents that include one or more of the key terms. In an exemplary embodiment, the newly derived term “Poker” is paired with the key term (“Chips”) in the search query 605 in which the derived term most commonly appears in proximity with. For instance, the term “Poker” may be initially selected for being a most prevalent key term within a group of search results that also include key terms from the search query 605. However, because the phrase “Poker Chip” is more common than any other combination of “Poker” and a key term in the search query 605, the derived term “Poker” is paired with the key term “Chips” within the preset suggestions 640.

With continued reference to FIG. 6, the “classification process” for determining when the reformulation UI 610, or any other corrective action, is presented will now be discussed. Generally, upon accessing a set of search results 620 returned from the issued search query 605, the search engine determines a level of quality of a portion of the complete set of search results 620 using the classification process. Initially, the classification process may involve applying various classifying criteria to one or more search results individually. In instances, the phrase “classifying criteria” broadly pertains to parameters for evaluating any feature demonstrated by the search results that can be examined. By way of example, some of the features demonstrated by the search results that may be evaluated are ranking features, quality-level features, caption-level features, session-level features, and aggregate features. In operation, one or more of these features may be targeted for evaluation and the evaluations of these feature(s) are aggregated to generate a level-of-quality score for each of the search results.

Initially, the ranking features represent those features that serve to measure a relationship between key terms within the search query 605 and contents of the set of search results 620 (e.g., documents, web page, blogs, and the like). In an exemplary embodiment, the ranking features pertain to query-dependent features of the search results 620, such as number of matches between the key terms of the search query 605 and content of the search results 620. Often, one or more of the ranking features are employed for the task of ranking the search results with respect to one another, in order to develop a search-result order on the SERP.

In one example, the ranking features may include a number/frequency of matches between terms in the search query and the title of the search result, anchor text pointing to the search result, body of the search result, and/or critical sections (e.g., top of page) of the search result. In embodiments, not all terms of the search query are considered. Typically, the search engine is concerned with whether the search results match, in some way, to the linguistic head (e.g., key terms, rare terms, and the like) of the search query. Accordingly, in embodiments, the linguistic head may be distilled from the search query and employed to evaluate ranking features of the search results, while non-critical, common, natural language of the search query may be ignored for purposes of classification.

In another example, the ranking features pertain to a proximity of matched key terms within the search results. Typically, the closer together the matched terms appear within the search results, the more relevant the search results are with respect to the search query, thus, warranting a high level of quality designation. As discussed throughout, a search result designated as having a high level of quality is usually assigned a high score within the absolute scale, which often translates into an absolute measurement of “good quality.”

The quality-level features generally represent features that individually quantify an overall quality of the set of search results independent of the search query. In embodiments, the overall quality is ascertained upon inspecting the contents/title/anchor text of a search result and/or a domain name integral to the search result. In one example, inspecting the contents of the search results involves enumerating a number of misspellings within a body of a document, where a large number of misspellings typically decreases a level of quality associated with the search results. In another example, inspecting the search result's domain involves determining whether the search result navigates to a trusted web site. As can be seen, the quality-level features focus on attributes of the search results independent of terms within the search query.

The caption-level features, in one instance, represent features that enumerate a number of matches between key terms within the search query and a search-engine prepared summary (i.e., snippet or instance answer) that is particular to each of set of search results. In another instance, the caption-level features pertain to a determination of whether the snippets are well formed (denoting a high-quality search results), or whether the snippets include incomplete sentences, American Standard Code for Information Interchange (ASCII) junk material, a multitude of numerals/symbols/uniform resource locators (URLs), and/or other non-textual data (denoting a poor-quality search result).

The session-level features generally represent features that label search results within the set of search results as either relevant or irrelevant based upon user-initiated refinements to the search results during a course of an online session. In one instance, the refinements pertain to a number of times the user revised the search query during the online session. Often, more refinements to the search query signify that the user is dissatisfied with the returned search results, which equates to lower levels of quality assigned to the search results presented in response to the search query. In another instance, the refinements pertain to an amount of user-interactions (e.g., selections) directed toward the search results that are generated based on the search query. Often, when little to no user-initiated selections (e.g., mouse click actions) are directed toward the search results, users are uninterested in the search results, thereby indicating that the search results are irrelevant or unpopular in some fashion. Generally, search results found to be unpopular are designated as having a low level of quality.

The aggregate features generally represent features that consider variation between contents of the set of search results, advertisements published at the search-results page, and/or terms comprising related searches offered by the search engine in tandem with the set of search results. As a general rule, in embodiments, high-quality search results are search results that exhibit a sufficient amount of inter-diversity with one another without being overly varied. In one instance, this inter-diversity is articulated as cross-result entropy. As used herein, “cross-result” entropy refers to the randomness, or inconsistencies, expressed by the constituents of the SERP. In one example, where the search results are similar (e.g., sharing one or two domains and/or exposing common subject matter within their content), the cross-result entropy is very low. This low cross-result entropy may occur upon the user entering an over-specified search query, which decreases the search-result level of quality because some inter-diversity is helpful to the user. In another example, where the search results are entirely distinct (e.g., encompassing a wide variety of domains and/or preventing clustering of search results due to lack of common subject matter within their content), the cross-result entropy is very high. This high cross-result entropy may occur upon the user entering an under-specified search query, which also decreases the search-result level of quality because too much inter-diversity is confusing to the user.

Although the content and domains associated with the search results have been described, it should be understood and appreciated that any other suitable attributes of the search results or suitable information on the SERP may be employed to calculate or influence the cross-result entropy, and embodiments of the present invention are not limited to the attributes described above. For instance, entropy between advertisements and/or related-searches data may be considered in adjusting a level of quality of the search results.

In a hypothetical example, the above-referenced features will now be discussed in relation to a search query 605 for “SHOW HOW MUCH BLUE DIAMOND CHIPS ARE WORTH,” where the user's intent of the search query 605 is to determine a value of “Blue Diamond” poker chips used for gambling at a particular casino. In some instances, as shown in FIG. 6, the search engine may distill the linguistic head from the search query 605 such that the key terms “blue,” “diamond,” “chips,” and “worth” are used in the classification process, while non-critical, common, natural language of the search query (e.g., “show how much”) may be ignored for purposes of classification. These distilled linguistic heads may be offered as the replacement search queries 630 within the reformulation UI 610. As shown, some of the replacement search queries 630 not only recommend removing all terms besides the key terms, but also offer suggested replacements for one or more of the key terms.

In other instances, the reformulation UI 610 prompts the user to individually alter any term within the search query 605, regardless of whether the term is designated as a key term. Thus, the user is allowed to manually target one or more terms of the search query 605 for alteration based on his or her own user intent, without substantial automated intervention. As discussed above, upon the user targeting and selecting a term to alter, the search query may be automatically updated with the altered term and transparently issued to the search engine, thereby dynamically generating a sampling of new search results in real time, which correspond to the updated search query.

As illustrated in the exemplary UI 600 of FIG. 6, a top-ranked search result 625 of the displayed search results 620 may be a document entitled “Wholesale Loose Diamond Chips.” This example search result 625 will be utilized within the discussion below to illustrate a functional application of the classification process. Initially, the ranking features of the example search result 625 may be applied to measure a relationship between the key terms within the search query 605 and contents of the example search result 625. In an exemplary embodiment, there may be a high number of matches between the search-query terms “Diamond,” “Chips,” and “Worth” while very few matches to “Blue.” Specifically, these matches may occur within the title, which includes “Diamond Chips,” and may occur frequently within the content of the search results. (This may be why the example search result 625 was a top-ranked search result with respect to the other search results 620 on the SERP.) As a result, the classification process may evaluate the example search result 625 as relevant to the user intent of the search query 605 upon analysis of the ranking features. Accordingly, the ranking features may identify the example search 625 result as a “good quality” search result and an outcome of the evaluation of the ranking features might be to incrementally raise the value of the score of the example search result within the absolute scale.

In another example, the quality-level features of the example search result 625 may be applied to individually quantify an overall quality of the example search results independent of the search query 605. In this hypothetical example, the overall quality of the example search result 625 is ascertained upon inspecting internal characteristics of the example search result 625. In one instance, the content of the example search result 625 may be inspected to enumerate a number of misspellings within a body of the document. Because the example search result 625 is maintained by a diamond-chip dealer, a large number of misspellings may be detected within the document's body (e.g., a comparatively greater frequency of misspellings with respect to an average web page). As a result, the classification process may evaluate the example search result 625 as of poor quality upon analysis of the quality-level features. Accordingly, the quality-level features may identify the example search result 625 as a “poor quality” search result and an outcome of the evaluation of the quality-level features might be to incrementally decrease the value of the score of the example search result 625 within the absolute scale.

In another instance, with respect to the quality-level features, the example search result's domain may be inspected to determine whether the example search result 625 navigates to a trusted web site. Again, because the example search result 625 is maintained by a diamond-chip dealer, the address for the web site that hosts the example search result 625 will likely be an non-trusted site, as opposed to the web site of a large, well-known, reputable company. As a result, the classification process may again evaluate the example search result 625 as having poor quality upon analysis of the quality-level features. Accordingly, the quality-level features may again identify the example search result 625 as a “poor quality” search result and may again incrementally decrease the value of the score of the example search result within the absolute scale.

In yet another example, the caption-level features of the example search result 615 may be applied to enumerate a number of matches between the key terms within the search query 605 and a search-engine prepared snippet of the example search result that reads “DIAMOND BUYING IS BUYER BEWARE SELLING . . . YOU GET A PICTURE THAT MAY SHOW THE DIAMOND IN ITS BEST COLORS.” In this snippet, the key term “Diamond” is matched twice, the key term “Blue” relates to the snipped term “Colors,” and the key terms “Chips” and “Worth” are not matched at all. As such, the classification process may evaluate the example search result 615 as having a poor snippet upon analysis of the caption-level feature.

In still another example, the session-level features of the example search result 615 may be applied to label the example search result 615 as either relevant or irrelevant based upon user-initiated refinements to the search results 620 during a course of an online session. In one instance, if the example search result 615 appeared in a SERP during the same online session and, in response to viewing the example search result 625, the user refined the search query, the session-level features indicate that the user is dissatisfied with the example search result 615 and the example search result is of poor quality. In another instance, if the example search result 615 appeared in a SERP during the same online session, but received little to no user-initiated selections (e.g., mouse click actions), the session-level features indicate that the user found the example search result irrelevant the user's intent.

In a final example, the aggregate features of the example search result 625 may be applied to consider variation between contents of the search results compared to the example search result 625. For instance, if all the search results, including the example search result 625, relate to diamond dealers (exposing common subject matter within their content), the cross-result entropy is very low, which decreases the search-result level of quality because some inter-diversity is helpful to the user.

Upon evaluating various features and/or other classifying criteria, the classification process may make a prediction of the search result level of quality. In an exemplary embodiment, the prediction is based on, in part, which rating (good or poor) each of the classifying criteria indicate upon evaluation. When a substantial number of the classifying criteria point in a common direction, the prediction is finalized. For instance, with reference to the hypothetical example above, the evaluation of the features above resulted in the following: ranking features indicated good quality; quality-level features indicated a poor quality; caption-level features indicated at poor quality; session-level features indicated a poor quality; and aggregate features indicated a poor quality. Because, four of the five classes of analytical features, upon application to the example search result 625, indicate the example search result 625 is of a poor quality, the prediction generated by the classification process may classify the example search result 615 as a low level of quality, thereby potentially triggering corrective action (e.g., presenting the reformulation UI 610).

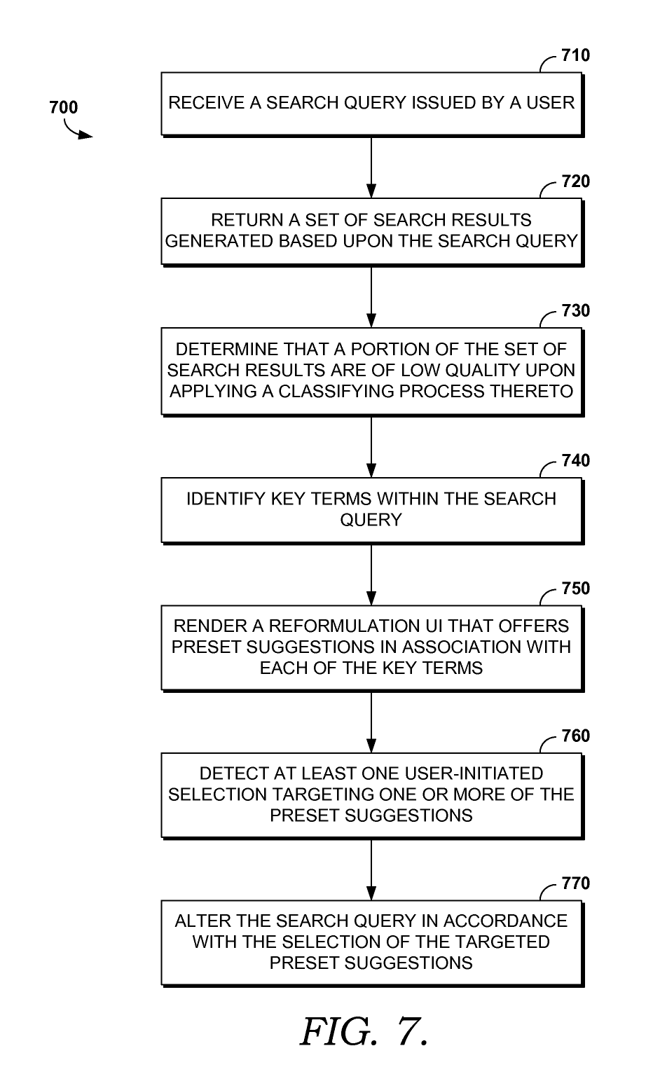

Turning now to FIG. 7, a flow diagram is shown depicting an illustrative method 700 for invoking a reformulation UI upon determining that a set of search results are of low quality, in accordance with embodiments of the invention. Initially, it should be appreciated and understood that although the terms “step” and/or “block” may be used herein to connote different elements of methods employed, the terms should not be interpreted as implying any particular order among or between various steps herein disclosed unless and except when the order of individual steps is explicitly described.

In an exemplary embodiment, the method 700 involves the steps of receiving a search query issued by a user (see block 710) and returning the set of search results generated based upon content of the search query (see block 720). The method 700 may further involve determining that a portion of the set of search results are of poor quality upon applying a classifying process thereto, as indicated at block 730.

In embodiments, as indicated at block 740, key terms are identified within the search query. Often, the key terms are identified by ignoring non-critical, common natural language from the search query. Upon determining that a set of search results are of low quality, the search engine may render the reformulation UI to expose to the user preset suggestions in association with each of the key terms, as indicated at block 750. When at least one user-initiated selection is detected that targets one or more of the preset suggestions (see block 760), the search query may be altered in accordance with the user-initiated selection on the targeted preset suggestion(s) (see block 770).

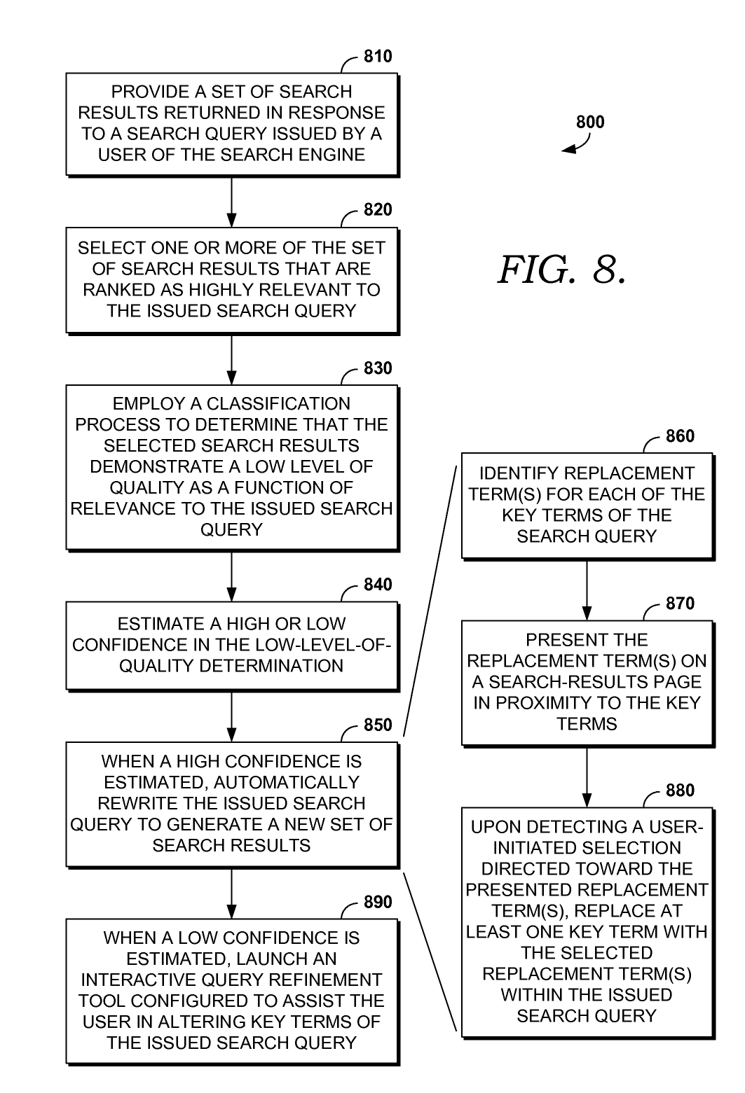

Referring to FIG. 8, a flow diagram is shown depicting illustrative method 800 for selecting a corrective action in response to low-quality search results, in accordance with embodiments of the invention. Initially, the method 800 may represent a computerized method carried out by a search engine (running on a processor). In embodiments, the method 800 includes providing a set of search results returned in response to a search query issued by a user of the search engine, as indicated at block 810. As indicated at block 820, the search engine may target one or more of the set of search results that are ranked as highly relevant to the issued search query. In embodiments, a determination that the targeted search result(s) demonstrate a low level of quality is made, as indicated at block 830. Typically, the determination of a low level of quality is made based on a relevance of the targeted search result(s) to the issued search query.

In an exemplary embodiment, as indicated at block 840, the search engine is responsible for estimating a high or low confidence, where a level of the confidence is based upon whether a rewritten search query will generate new search results that are more relevant to the issued query than the returned set of search results. The rewritten search query, in embodiments, is automatically generated by the search engine upon determining that the targeted search result(s) demonstrate a low level of quality. In one instance, as indicated at block 850, when a high confidence is estimated, the search engine automatically issues the rewritten search query to generate the new search results. In another instance, as indicated at block 890 when a low confidence is estimated, the search engine launches an interactive query refinement tool that assists the user in altering key terms of the issued search query.

Generally, as discussed more fully below, the interactive query refinement tool is responsible for implementing actions. Some exemplary actions include identifying one or more replacement terms for each of the key terms of the search query (see block 860) and presenting the replacement term(s) on a search-results page in proximity to the key terms (see block 870). In operation of the tool, as indicated at block 880, at least one key term within the issued search query is replaced by the selected replacement term(s) upon detecting a user-initiated selection directed toward the presented replacement term(s).

Various embodiments of the invention have been described to be illustrative rather than restrictive. Alternative embodiments will become apparent from time to time without departing from the scope of embodiments of the inventions. It will be understood that certain features and sub-combinations are of utility and may be employed without reference to other features and sub-combinations. This is contemplated by and is within the scope of the claims.

The invention claimed is:

1. One or more computer-readable media having embodied thereon computer-executable instructions that, when executed, perform a method for invoking a reformulation user interface (UI) upon determining that a set of search results are of low quality, the method comprising:
receiving a search query issued by a user;
returning the set of search results generated based upon content of the search query;
determining that a portion of the set of search results are of poor quality upon applying a classifying process thereto;
identifying key terms within the search query;
rendering the reformulation UI to expose to the user preset suggestions in association with each of the key terms, wherein the reformulation UI prompts the user to dynamically alter the identified key terms individually;
detecting at least one user-initiated selection targeting one or more of the preset suggestions; and
altering the search query in accordance with the at least one user-initiated selection on the one or more targeted preset suggestions.

2. The media of claim 1, wherein the classification process comprises:
determining a level of quality of the set of search results individually by applying a plurality of classifying criteria thereto;
assigning at least one search result of the set of search results a score within an absolute scale based upon the determined level of quality; and
comparing the score against a threshold value within the absolute scale.

3. The media of claim 2, wherein the classification process further comprises:
classifying the at least one search result as being of good quality upon the comparison revealing that the score is greater than the threshold value; and
classifying the at least one search result as being of poor quality upon the comparison revealing that the score is less than the threshold value.

4. The media of claim 1, wherein the method further comprises:
ranking search results of the set of search results against one another based on, in part, relevance to a user intent implicit within the search query; and
targeting high-ranked search results within the ranking for receiving application of the classification process.

6. The media of claim 1, wherein identifying key terms within the search query comprises ignoring non-critical, common natural language from the search query.

7. The media of claim 1, wherein rendering the reformulation UI comprises presenting a selectable control proximate to a respective preset suggestion.

8. The media of claim 7, wherein the selectable control comprises at least one of a check box or a radio button.

9. The media of claim 8, wherein detecting at least one user-initiated selection targeting one or more of the preset suggestions comprises detecting the user-initiated selection upon the selectable control proximate to a respective preset suggestion.

10. The media of claim 1, wherein the preset suggestions include a drop option that allows a user to remove a key term corresponding to the drop option from the search query.

11. The media of claim 1, wherein the preset suggestions include at least one replacement term that allows a user to replace a key term corresponding to the replacement term inside the search query.

12. The media of claim 1, wherein the preset suggestions include an add option that allows a user to incorporate a new term to the search query.

13. The media of claim 1, wherein the method further comprises presenting on a search-results page the search query issued by the user and an altered search query upon detecting the user-initiated selection on one or more of the preset suggestions, wherein the altered search query reflects alterations made to the user-issued search query via the reformulation UI.

14. The media of claim 1, wherein the method further comprises abstaining from showing the portion of the set of search results upon determining that the portion of the set of search results are of poor quality.

15. The media of claim 1, wherein the method further comprises:
upon altering the search query, automatically generating a new set of search results using the altered search query; and
dynamically presenting a preview of the new set of search results.

16. A computer system for invoking a reformulation user interface (UI), the computer system comprising a processing unit coupled to a computer-storage medium, the computer storage medium having stored thereon a plurality of computer software components executable by the processing unit, the computer software components comprising:
a query-receiving component to receive a search query issued by a user and to return the set of search results generated based upon the search query;
a classifying component to identify the query-receiving component returned one or more search results of poor quality within the set of search results;
an application component to invoke an appropriate corrective action upon detecting the one or more poor-quality search results,
wherein the appropriate corrective action is selected based on, in part, a level of confidence in an automatically rewritten search query producing new search results that are more relevant to the user's intent of the issued search query than the returned set of search results,
wherein the appropriate corrective action comprises rendering the reformulation UI when the level of confidence is determined to be low, wherein the reformulation UI prompts the user to dynamically alter terms within the issued search query individually; and
wherein the appropriate corrective action comprises issuing the automatically rewritten search query to generate the new set of search results when the level of confidence is determined to be high.

17. A computerized method carried out by a search engine running on a processor for selecting a corrective action in response to low-quality search results, the method comprising:
providing a set of search results returned in response to a search query issued by a user of the search engine;
targeting one or more search results of the set of search results that are ranked as highly relevant to the issued search query;
determining that the one or more targeted search results demonstrate a low level of quality as a function of relevance to the issued search query;
estimating a high or low confidence in a rewritten search query generating new search results that are more relevant to the issued query than the returned set of search results, wherein the rewritten search query is automatically generated by the search engine upon determining that the one or more targeted search results demonstrate a low level of quality;
when a high confidence is estimated, automatically issuing the rewritten search query to generate the new search results; and
when a low confidence is estimated, launching an interactive query refinement tool that assists the user in altering key terms of the issued search query, wherein the interactive query refinement tool is responsible for implementing actions comprising:
(a) identifying one or more replacement terms for each of the key terms of the search query;
(b) presenting the one or more replacement terms on a search-results page in proximity to the key terms; and
(c) upon detecting a user-initiated selection directed toward the one or more presented replacement terms, replacing at least one key term within the issued search query with the one or more selected replacement terms.

18. The computerized method of claim 17, wherein identifying one or more replacement terms comprises accessing a group of candidate terms for each of the key terms of the search query, where the group of candidate terms are linked to a respective key term via a pre-established navigation path, and wherein the pre-established navigation path is built by monitoring user interactions with the search engine.

19. The computerized method of claim 18, wherein the user interactions with the search engine comprise at least one of multi-user search behavior that indicates the group of candidate terms are interchangeable with a respective key term linked thereto, or individual-user activity during a single search session that indicates the group of candidate terms are employed to refine a respective key term linked thereto.

20. The computerized method of claim 19, wherein identifying one or more replacement terms comprises:
ranking each of the candidate terms within the group based, in part, on a frequency at which a particular candidate term is interchanged with or employed to refine a respective key word; and
promoting the candidate terms having a highest ranking within the group to the one or more replacement terms.
